(19) United States
(12) Patent Application Publication
(10) Pub. No.: US 2008/0105107 A1
(43) Pub. Date: May 8, 2008

(54) Method for Automatically Tuning a String Instrument, Particularly an Electric Guitar

(76) Inventor: Christopher Adams, Hamburg (DE)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/814,150

(22) PCT Filed: Jan. 19, 2005
(86) PCT No.: PCT/EP05/00479

§ 371 Date: Sep. 28, 2007

(51) Int. Cl. G10G 7/02

(52) U.S. Cl. 84/455

(57) ABSTRACT

The invention relates to a procedure for automatic tuning of a stringed instrument, especially an electric guitar, whereby by means of a drive guided automatically by a control device and a string-tensioning device coupled to the drive, at least one string to be tuned can be tensioned or de-tensioned, to tune this string to a basic tone capable of being pre-set. The task of the invention is to provide such a procedure that without a comparison between a de-facto pitch and a target pitch (a de-facto frequency and a target frequency) results in attainment at least of an initial tuning, characterized in that at least for a pre-tuning, determination is made by the drive of a tensioning force or an appropriate torque to maintain the string in the current tension, and this value is compared with a comparison value for a correct pitch for a string tensioning, and if there is a deviation from this comparison value, the drive is guided so that it holds the string with an appropriate force or such a torque that corresponds to this comparison value.

The present invention relates to a procedure for automatic tuning of a stringed instrument, especially an electric guitar.

Generally, tuning of instruments requires, in addition to a trained ear, an amount of time that must be spent, especially by untrained persons, particularly hobby instrumentalists. In the classical procedure for tuning “by hand,” the musician works with a tuning fork that presets the desired pitch by being struck, and he makes adjustments in the pitch of the particular string by altering the length or tension of the string. Through multiple pluckings of the string and strikings of the tuning fork, the result is adjusted until the string reaches the desired pitch. Proceeding from this pitch, the other strings are then tuned.

On the one hand the strings of an instrument must be regularly tuned due to the material constantly being pliant, and on the other hand the strings can change in length due to climatic conditions. A guitar string on the stage of a concert hall will extend due to the heat and humid air as compared with the conditions in relatively dry and cool practice rooms. Therefore frequent tuning is required. Also, after new strings are put on, they have to be tuned.

To facilitate this, a device for automatic tuning of a stringed instrument was proposed in U.S. Pat. No. 4,803,908, which works with a frequency adjustment. With this device, on a guitar with an aid called a “strummer” that is placed in the body of the guitar, all the strings are plucked simultaneously. An electronic device records the pitches, compares them with preset target ones, and guides an adjustment device attached to the strings to adjust string tensions in such a way that they reach the preset pitches.

This is a much-to-be-welcomed system, in that it makes possible automatic tuning and thus relieves especially untrained musicians as well as professionals of a great deal of expenditure. But the system has a substantial disadvantage. Particularly if the tuning of the strings deviates more drastically from the target tuning, it is slow, because it requires frequent checks on the frequency attained by the tuning and comparisons with the preset target pitch. This is particularly true for the initial tuning of the string after it has been put on.

The invention proceeds from the problem described. It has the task of providing a procedure that, without a comparison between a de-facto pitch and a target pitch (a de-facto frequency and a target frequency) results in attainment at least of an initial tuning.

For solving this problem, a procedure is proposed with the features of patent claim 1.

Additionally, for more detailed tuning of the stringed instrument, a procedure is proposed with the features of claim 2.

The basic principle of the invention consists, at least for an initial automatic “startup tuning,” not to use a pitch adjustment or frequency adjustment, but to monitor the string for a string tension characteristic of the desired pitch, and to make this string tension adjustment automatically. According to the invention, the appropriate torque is determined by the drive for exerting the force to maintain the current string tension, and compared with an appropriate target value of a pitch sought after for the string. Then the drive is guided so that when it reaches the force necessary to attain or maintain the string tension at the desired pitch, it applies the torque needed for this. While this is occurring the string is appropriately tensioned or de-tensioned, and an initial tuning occurs. Using an electric guitar as an example, using this procedure and starting with a totally untuned string, a frequency precision of ±1% is achieved.

According to the invention, to increase tuning precision, this procedure can be combined with a customary tuning procedure, that involves an adjustment according to a de-facto pitch and a target one, or a de-factor frequency and a target one. What is problematical with the last-named procedure is always tuning if the string deviates drastically from its target pitch. Then many cycles of applying more and less tension are required, and possibly it may be necessary to repeatedly pluck a string. Here the further development provided in claim 2 is used. First, proceeding from a still satisfactory tuning rate, a frequency range around the target frequency is determined, within which the pure tuning according to frequency adjustment operates rapidly enough.

Then, with the invention-specific procedure, first a determination is made upon plucking the string—and this can even be a stimulation when a new string is applied—as to whether a frequency can be determined at all, and whether this frequency lies within the previously established frequency range about the target frequency. If a frequency cannot be determined, or if the frequency lies outside the range, first a force- or torque-controlled tuning is done, until the target frequency or target tuning is achieved in rough terms. In every case the frequency attained lies within the preset frequency window. From then on, further tuning is done with the known automatic tuning method by frequency adjustment. In practice, guidance of this sequence is done in an automatic tuning device by means of software, whereby the decision as to whether the frequency-dependent tuning should be proceeded by a force- or torque-dependent pre-tuning or not, is made by the software or by the controls guided by the software within the briefest time period. Likewise, guidance is provided for the transition between the force- or torque-controlled pre-tuning and the frequency or pitch-dependent fine-tuning by the software automatically, where, due to the quick reaction and quick tuning, no second plucking of the string is necessary as a rule.

For a guitar, with this method, a newly applied string could be tuned within 4 seconds, with this time fully capable of being bettered through further improvement in the algorithms and sequences integrated into the control software.

Thus with this invention a procedure is provided for automatic tuning of a stringed instrument, especially an electronic guitar, permitting quick and precise tuning. With such a procedure, or with a device or system operating according to such a procedure, it is also possible for musicians to re-tune their stringed instrument automatically during very brief pauses between playing.

1. A procedure for automatic tuning of a stringed instrument comprising by means of a drive that can be guided by a control device and a string tensioning device tuning at least one string to a pre-set basic tone by tensioning or de-tensioning the string, wherein at least for a pre-tuning, determining the drive of a tensioning force or an appropriate torque to maintain the string in the current tension, and comparing this value with a comparison value for a correct pitch for a string tensioning, and if there is a deviation from this comparison value, the drive is guided so that it holds the string with an appropriate force or such a torque that corresponds to this comparison value.

2. A procedure for automatic tuning of a stringed instrument, comprising generating a pitch by plucking a string and recording and converting the pitch into a digital signal,
from this digital signal, determining a frequency that pertains to base tone of the vibrating string,
comparing this frequency with a pre-set target frequency, and if there are deviations from the target frequency, the string is tensioned or de-tensioned until the frequency currently vibrates in a basic pitch of the string and
corresponds at least within a pre-set tolerance limit with the target frequency,
wherein a determination is made of whether the frequency of the basic pitch generated by striking the string lies within a pre-set range about the target frequency, and wherein
in a case where this frequency lies outside the pre-set range, or in a case in which a frequency cannot be determined,
the procedure according to claim 1 is carried out.
